(19) United States
(12) Patent Application Publication
(10) Pub. No.: US 2026/0229726 A1
(43) Pub. Date: Aug. 6, 2026

(54) METHOD OF MANUFACTURING ELECTRODE STACK MODULE

(71) Applicant: TOYOTA JIDOSHA KABUSHIKI KAISHA, Toyota-shi (JP)

(72) Inventor: Seigo FUJISHIMA, Miyoshi-shi (JP)

(73) Assignee: TOYOTA JIDOSHA KABUSHIKI KAISHA, Toyota-shi (JP)

(21) Appl. No.: 19/385,179

(22) Filed: Nov. 11, 2025

(30) Foreign Application Priority Data
Jan. 30, 2025 (JP) 2025-014162

(51) Int. Cl. H01M 50/536; B23K 26/21

(52) U.S. Cl. CPC H01M 50/536; B23K 26/21

(57) ABSTRACT

A method of manufacturing an electrode stack module according to the present disclosure includes (a) providing an electrode stack in which an end part of a current collector layer protrudes, (b) stacking a first resin sealing member, an electrode stack, and a second resin sealing member in this order at the end part, and (c) heating the current collector layer by irradiating the current collector layer with a laser beam, welding each of the current collector layer, the first resin sealing member, and the second resin sealing member, in which a wavelength of the laser beam satisfies the following (i) and (ii), (i) an absorption rate of the laser beam in the current collector layer is 50% or more, and (ii) an absorption rate of the laser beam in the first resin sealing member is 10% or less.

### CROSS-REFERENCE TO RELATED APPLICATION

This application claims priority to Japanese Patent Application No. 2025-014162 filed on January 30, 2025. The disclosure of the above-identified application, including the specification, drawings, and claims, is incorporated by reference herein in its entirety.

### BACKGROUND

### 1. Technical Field

The present disclosure relates to a method of manufacturing an electrode stack module.

### 2. Description of Related Art

An electrode stack module generally refers to an electrode stack accommodated in an outer case or the like. In the electrode stack, a positive electrode current collector layer, a positive electrode active material layer, a separator layer or a solid electrolyte layer, a negative electrode active material layer, and a negative electrode current collector layer are stacked in this order. The electrode stack module is manufactured, for example, by stacking a current collector foil and a resin sealing member alternately and thermally welding the stacked current collector foil and resin sealing members to seal a space between the electrode stacks.

For example, WO 2024/106143 discloses a method of manufacturing a power storage module that is performed in the following steps.

(i) a first step of preparing a stack including an electrode stack and a sealing body. The electrode stack is configured by stacking a plurality of electrodes along a first direction. The electrodes each include a current collector on which an active material layer is provided and a detection line provided on the current collector. The sealing body is provided on the electrode stack to surround the electrode stack, and is for sealing an internal space between the current collectors adjacent to each other in the first direction while each of the detection lines of the electrodes is drawn out to the outside.

(ii) a second step of installing, after the first step, a resin component including a hole portion into which the detection line is inserted, on the stack such that the resin component faces a drawing-out portion of the detection line in the sealing body and a space is present between the resin component and the drawing-out portion, and inserting a portion of the detection line that is drawn out from the drawing-out portion of the detection line, into the hole portion of the resin component.

(iii) a third step of forming a filling resin layer integrated with the sealing body by filling the space between the drawing-out portion and the resin component with a resin using a mold after the second step, and obtaining a power storage module including the stack, the resin component, and the filling resin layer. In the third step, the sealing body and the resin component are held by the mold to form a space surrounded by the sealing body, the resin component, and the mold, and the filling resin layer is formed by filling the space with the resin. With the method of manufacturing a power storage module described in WO 2024/106143, damage to the detection line can be suppressed, and the sealing body and the filling resin layer can be firmly integrated with each other by the miscibility of the sealing body and the resin for the filling resin layer, or the like.

In addition, in WO 2023/189249, there are provided an electrode stack formed by stacking a plurality of bipolar electrodes and a sealing body. The bipolar electrodes each include a pair of electrodes including a current collector and an active material layer provided on each of a first surface and a second surface of the current collector. The sealing body seals a side surface of the electrode stack extending in a stacking direction of the bipolar electrodes. The sealing body includes a plurality of frame-shaped seal members and a plurality of frame-shape spacers. The seal members are each welded to an edge portion of each of the current collectors. The frame-shaped spacers are each disposed between the seal members adjacent to each other in the stacking direction. An outer edge portion of each of the spacers that protrudes outward of the edge portion of the current collector and an outer edge portion of each of the seal members that is adjacent to a corresponding one of the spacers in the stacking direction and protrudes outward of the edge portion of the current collector are welded to each other to form an outer surface of the sealing body. A power storage device is disclosed in which the melt mass flow rate of a resin material constituting the spacer is larger than the melt mass flow rate of a resin material constituting the seal member. With the power storage device described in WO 2023/189249, the sealing body has higher hermeticity while a spacing between the current collectors is more suitably maintained.

### SUMMARY

In a method of manufacturing an electrode stack module, when a resin sealing member is welded to a current collector layer, the electrode stack module is heated from a side surface of the electrode stack module, and a resin sheet and a resin spacer are thermally welded. In this case, since the resin sheet and the resin spacer are stacked to protrude outward of the current collector layer in order to provide a thermally welded portion of the resin sheet and the resin spacer, the size of the electrode stack module is increased, and thus a structural efficiency is decreased. In the present disclosure, the structural efficiency is a ratio of the volume of the electrode stack in which a battery reaction is performed to the total volume of the electrode stack module.

In addition, when the resin sheet is welded to both surfaces of the current collector layer and then the resin sheet and the resin spacer are welded, the number of components is increased, and thus the number of welding steps is increased.

Therefore, an object of the present disclosure is to provide a method of efficiently manufacturing an electrode stack module having improved structural efficiency.

The present disclosure achieves the object by the following methods.

### Aspect 1

A method of manufacturing an electrode stack module includes:

(a) providing an electrode stack that includes a positive electrode active material layer, a current collector layer, and a negative electrode active material layer in this order, and in which an end part of the current collector layer protrudes;

(b) stacking a first resin sealing member, the electrode stack, and a second resin sealing member in this order at the end part: and

(c) heating the end part of the current collector layer by irradiating the end part with a laser beam through the first resin sealing member from a stacking direction of the electrode stack, and welding each of one surface of the end part and the first resin sealing member, the other surface of the end part and the second resin sealing member, and the first resin sealing member and the second resin sealing member. In the method, a wavelength of the laser beam satisfies both of (i) and (ii):

(i) an absorption rate of the laser beam in the current collector layer is 50% or more; and

(ii) an absorption rate of the laser beam in the first resin sealing member is 10% or less.

### Aspect 2

In the method according to aspect 1, (c) includes irradiating with the end part with the laser beam while the current collector layer and the first resin sealing member are pressurized with a pressurizing member transparent to the laser beam.

### Aspect 3

In the method according to aspect 1 or 2, the wavelength of the laser beam is from 285 nm to 1150 nm.

### Aspect 4

In the method according to any one of aspects 1 to 3, a thickness of the first resin sealing member is 800 μm or more.

### Aspect 5

In the method according to any one of aspects 1 to 4, a width of the first resin sealing member is 200 mm or less.

With the method of the present disclosure, it is possible to efficiently manufacture an electrode stack module having improved structural efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic view for describing a difference between the related art and the present embodiment;

FIG. 1B is a schematic view for describing a difference between the related art and the present embodiment;

FIG. 1C is a schematic view for describing a difference between the related art and the present embodiment;

FIG. 2 is a top view for describing the method of the present disclosure;

FIG. 3 is a cross-sectional view for describing the method of the present disclosure;

FIG. 4 is a cross-sectional view for describing the method of the present disclosure; and

FIG. 5 is a graph showing an absorption rate of a laser beam to a wavelength in Embodiment of the present disclosure.

### DETAILED DESCRIPTION OF EMBODIMENTS

Hereinafter, the embodiment of the present disclosure will be described in detail. The present disclosure is not limited to the following embodiments, and can be variously modified and implemented within the spirit of the present disclosure. In addition, the same elements in the drawings are designated by the same reference numerals, and redundant description thereof will be omitted.

### Method of Manufacturing Electrode Stack Module

A method of manufacturing an electrode stack module includes:

(a) providing an electrode stack including a positive electrode active material layer, a current collector layer, and a negative electrode active material layer in this order, in which an end part of the current collector layer protrudes;

(b) stacking a first resin sealing member, the electrode stack, and a second resin sealing member in this order at the end part; and

(c) heating the end part of the current collector layer by irradiating the end part with a laser beam through the first resin sealing member from a stacking direction of the electrode stack, and welding each of one surface of the end part and the first resin sealing member, the other surface of the end part and the second resin sealing member, and the first resin sealing member and the second resin sealing member, in which:

a wavelength of the laser beam satisfies the following (i) and (ii);

(i) an absorption rate of the laser beam in the current collector layer is 50% or more; and

(ii) an absorption rate of the laser beam in the first resin sealing member is 10% or less.

With the method, it is possible to efficiently manufacture an electrode stack module having improved structural efficiency.

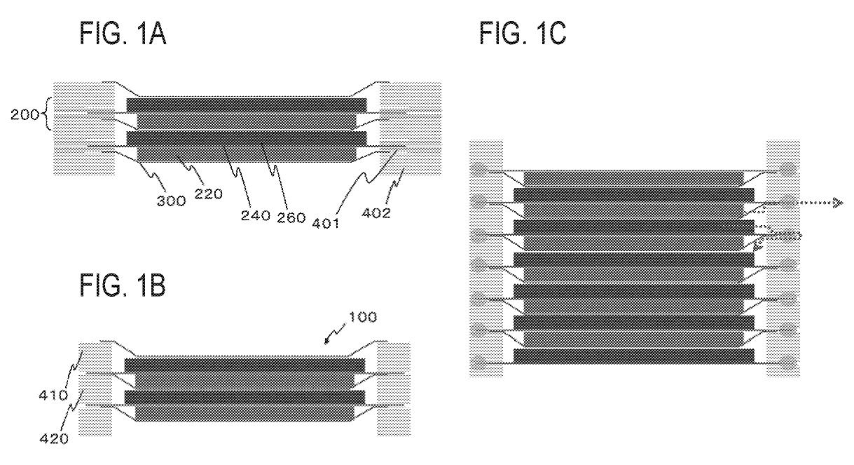

In the method in the related art, as shown in FIG. 1A, for example, a plurality of frame-shaped resin sheets 401 is welded in advance to an edge portion of each of current collector layers 240, a plurality of frame-shaped resin spacers 402 is disposed between the resin sheets 401 adjacent to each other in the stacking direction, and the resin sheets 401 and the resin spacers 402 are welded to each other to manufacture an electrode stack module. The welding is performed, for example, by heating from a side surface. As a result, an electrode stack 200 can be sealed by sufficiently performing the welding, and thus it is possible to suppress the leakage of the electrolytic solution.

However, in the method, in a case where the resin sheet 401 and the resin spacer 402 are thermally welded, the resin sheet 401 and the resin spacer 402 are stacked to protrude outward of the current collector layer. Therefore, the size of the electrode stack module is increased, and thus the structural efficiency is decreased. In addition, in a case where the resin sheet 401 is welded to each of both surfaces of the current collector layer and then the resin sheet 401 and the resin spacer 402 are welded, the number of components is increased, and thus the number of welding steps is increased.

On the other hand, in the method of the present disclosure, the first resin sealing member, the electrode stack, and the second resin sealing member are stacked in this order at the end part of the current collector layer, and the end part of the current collector layer is heated by irradiating the end part with a laser beam through the first resin sealing member from the stacking direction of the electrode stack. As a result, each of one surface of the end part and the first resin sealing member, the other surface of the end part and the second resin sealing member, and the first resin sealing member and the second resin sealing member is welded.

As a result, since the laser beam irradiation is performed through the first resin sealing member from the stacking direction of the electrode stack, the electrode stack can be sufficiently sealed without providing a thermally welded portion of the resin sealing member. Therefore, the resin sealing member can be reduced in size, and thus the size of the electrode stack module can be reduced. In a case where the current collector layer and the resin sealing member are not sufficiently welded, as shown in FIG. 1C, there is a concern that the electrolytic solution may leak from between the adjacent resin sealing members and/or between the resin sealing member and the current collector layer, respectively, to the outside of the electrode stack module and/or a space sealed by the adjacent electrode stack.

In addition, since the current collector layer and the resin sealing member can be sufficiently welded by performing irradiation with the laser beam from the stacking direction of the electrode stack, the electrode stack can be sufficiently sealed even in a case where the number of components and the number of welding steps are reduced.

FIG. 1B shows one embodiment of the present disclosure, but the present disclosure is not limited thereto. A first resin sealing member 410, the electrode stack 200, and a second resin sealing member 420 are stacked in this order at the end part of the current collector layer 240. The laser beam irradiation is performed through the first resin sealing member 410 from the stacking direction of the electrode stack 200 to heat the end part of the current collector layer 240. As a result, each of one surface of the end part and the first resin sealing member 410, the other surface of the end part and the second resin sealing member 420, and the first resin sealing member 410 and the second resin sealing member 420 is welded.

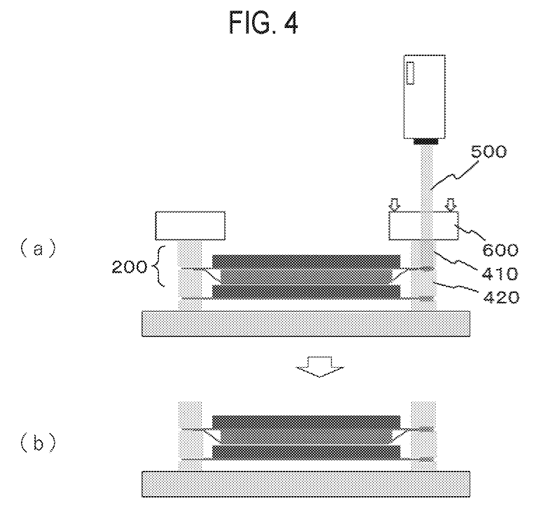

In addition, in the method of the present disclosure, the laser beam irradiation is performed through the first resin sealing member to the end part of the current collector layer from the stacking direction. Therefore, in a case where a plurality of electrode stacks is stacked, as shown in FIG. 4, the end part of the current collector layer of the electrode stack close to the laser beam among the electrode stacks is heated by the irradiation with the laser beam. Therefore, the electrode stack module in which the electrode stacks are stacked can be manufactured by repeating the method of the present disclosure, that is, by repeating the lamination of the electrode stack and the resin sealing member and the irradiation with the laser beam.

### Step a

In the method of manufacturing an electrode stack module according to the present disclosure, first, an electrode stack including a positive electrode active material layer, a current collector layer, and a negative electrode active material layer in this order, in which an end part of the current collector layer protrudes, is provided. Specifically, the electrode stack can be provided by coating each of the positive electrode active material layer and the negative electrode active material layer on one surface of the current collector layer and the other surface of the current collector layer.

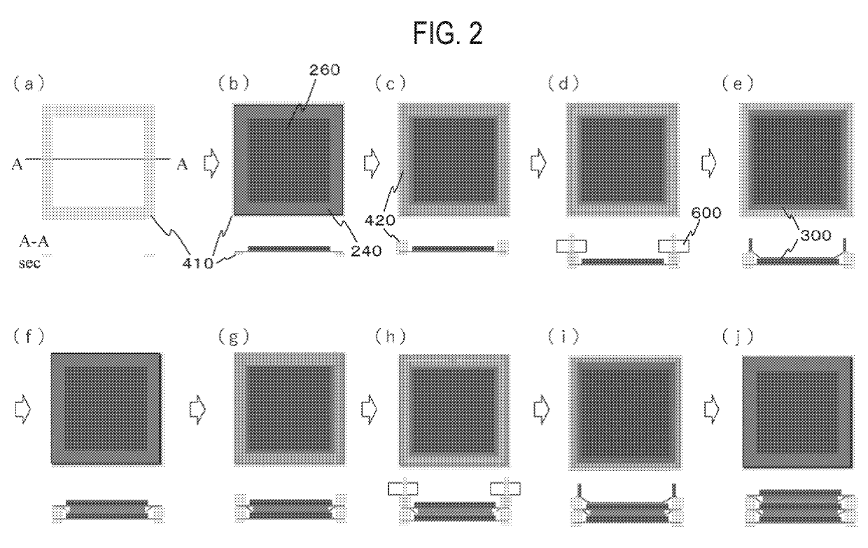

Details of the method of manufacturing an electrode stack module according to the present disclosure are shown in FIG. 2, but the embodiment of the present disclosure is not limited thereto. In the present disclosure, first, an electrode stack 200 is provided, in which a positive electrode active material layer 220, the current collector layer 240, and a negative electrode active material layer 260 are stacked in this order (part (b) of FIG. 2). In this case, the end part of the current collector layer 240 protrudes.

### Electrode Stack

In the present disclosure, the electrode stack includes a positive electrode active material layer, a current collector layer, and a negative electrode active material layer in this order, in which an end part of the current collector layer protrudes.

### Positive Electrode Active Material Layer

In the present disclosure, the positive electrode active material layer is provided in the electrode stack. The positive electrode active material layer of the present disclosure includes at least positive electrode active material particles, and may optionally include a solid electrolyte, a binder, and a conductive auxiliary agent.

A content of the positive electrode active material in the positive electrode active material layer of the present disclosure is not particularly limited. The content may be 1% by mass or more, 5% by mass or more, 10% by mass or more, or 15% by mass or more, and may be 50% by mass or less, 45% by mass or less, 40% by mass or less, or 35% by mass or less.

A material of the positive electrode active material may be any known material as a positive electrode active material used in a secondary battery, and is not particularly limited.

The positive electrode active material may have any shape, and may be, for example, spherical or fibrous.

A particle diameter D₅₀ of the positive electrode active material is not particularly limited, but may be, for example, 1 nm or more, 5 nm or more, or 10 nm or more, and may be 500 μm or less, 100 μm or less, 50 μm or less, or 30 μm or less. The particle diameter D₅₀ is a particle diameter (median diameter) at a cumulative value of 50% in a volume-based particle size distribution obtained by a laser diffraction and scattering method.

The solid electrolyte optionally included in the positive electrode active material layer of the present disclosure may be a known solid electrolyte as a solid electrolyte of a secondary battery. Examples of the solid electrolyte include an inorganic solid electrolyte, such as a sulfide solid electrolyte and an oxide solid electrolyte, and an organic polymer electrolyte, such as a polymer electrolyte. From the viewpoint of heat resistance, the electrolyte is preferably a sulfide solid electrolyte or an oxide solid electrolyte. The solid electrolyte may be, for example, in a particle shape. One kind of solid electrolyte may be used alone, or two or more kinds of solid electrolytes may be used in combination.

Examples of the sulfide solid electrolyte include Li₂S-P₂S₅, LiI-LiBr-Li₂S-P₂S₅, and Li₂S-GeS₂, but the sulfide solid electrolyte is not limited thereto. The sulfide solid electrolyte may be glass (amorphous) or glass ceramics.

Examples of the oxide solid electrolyte include Li₇La₃Zr₂O₁₂ and Li₇₋₃ₓLa₃Zr₂AlₓO₁₂, but the oxide solid electrolyte is not limited thereto. The oxide solid electrolyte may be amorphous or crystalline.

Examples of the polymer electrolyte include polyethylene oxide (PEO), polypropylene oxide (PPO), and a copolymer thereof, but the polymer electrolyte is not limited thereto.

A content of the solid electrolyte optionally included in the positive electrode active material layer of the present disclosure is not particularly limited. The content may be 1% by mass or more, 5% by mass or more, 10% by mass or more, or 13% by mass or more, and may be 60% by mass or less, 50% by mass or less, 40% by mass or less, or 30% by mass or less.

In the present disclosure, a known conductive auxiliary agent as a conductive auxiliary agent used in a secondary battery may be used as the conductive auxiliary agent optionally included in the positive electrode active material layer. Specific examples of the conductive auxiliary agent include a carbon material, such as vapor-grown carbon fiber (VGCF), carbon nanotube (CNT), carbon nanofiber (CNF), and graphite. As the conductive auxiliary agent, a metal material that can withstand an environment at the time when the electrode stack module is used can also be used. One kind of conductive auxiliary agent may be used alone, or a combination of two or more kinds of conductive auxiliary agents may be used. The shape of the conductive auxiliary agent may be various shapes, such as a powder shape and a fiber shape.

A content of the conductive auxiliary agent optionally included in the positive electrode active material layer of the present disclosure is not particularly limited. The content may be 0.1% by mass or more, 0.5% by mass or more, 1% by mass or more, or 3% by mass or more, and may be 20% by mass or less, 15% by mass or less, 10% by mass or less, or 8% by mass or less.

As the binder optionally included in the positive electrode active material layer of the present disclosure, a known binder as a binder used in a secondary battery may be used. Examples of the binder include styrene butadiene rubber (SBR), carboxymethyl cellulose (CMC), butadiene rubber (BR), polyvinylidene fluoride (PVDF), and polytetrafluoroethylene (PTFE). One kind of binder may be used alone, or a combination of two or more kinds of binders may be used.

A content of the binder optionally included in the positive electrode active material layer of the present disclosure is not particularly limited. The content may be 0.1% by mass or more, 0.5% by mass or more, 1% by mass or more, or 3% by mass or more, and may be 20% by mass or less, 15% by mass or less, 10% by mass or less, or 8% by mass or less.

### Current Collector Layer

In the present disclosure, the current collector layer is provided in the electrode stack, and an end part of the current collector layer protrudes.

The positive electrode active material layer and/or the negative electrode active material layer may not be coated on the end part of the current collector layer of the present disclosure, or may be coated on a part of the end part of the current collector layer.

In the present disclosure, examples of a material of the current collector layer include copper, aluminum, an aluminum alloy, stainless steel, and nickel, but the present disclosure is not limited thereto.

In the present disclosure, a thickness of the current collector layer is not particularly limited. The thickness may be 10 μm or more, 20 μm or more, 30 μm or more, or 40 μm or more, and may be 100 μm or less, 80 μm or less, 70 μm or less, 60 μm or less, or 50 μm or less.

### Negative Electrode Active Material Layer

In the present disclosure, the negative electrode active material layer is provided in the electrode stack. The negative electrode active material layer of the present disclosure includes at least negative electrode active material particles, and may optionally include a solid electrolyte, a binder, and a conductive auxiliary agent.

As the negative electrode active material, a known negative electrode active material used in a secondary battery can be used, and is not particularly limited.

In the present disclosure, a dimension of the negative electrode active material layer may be larger than a dimension of the positive electrode active material layer in a case of being viewed from the stacking direction of the electrode stack.

For details of the negative electrode active material layer, the negative electrode active material, and the solid electrolyte, the binder, and the conductive auxiliary agent optionally included in the negative electrode active material layer of the present disclosure, reference can be made to the description of the positive electrode active material layer of the present disclosure.

### Step b

Next, in the method of manufacturing an electrode stack module according to the present disclosure, the first resin sealing member, the electrode stack, and the second resin sealing member are stacked in this order at the end part.

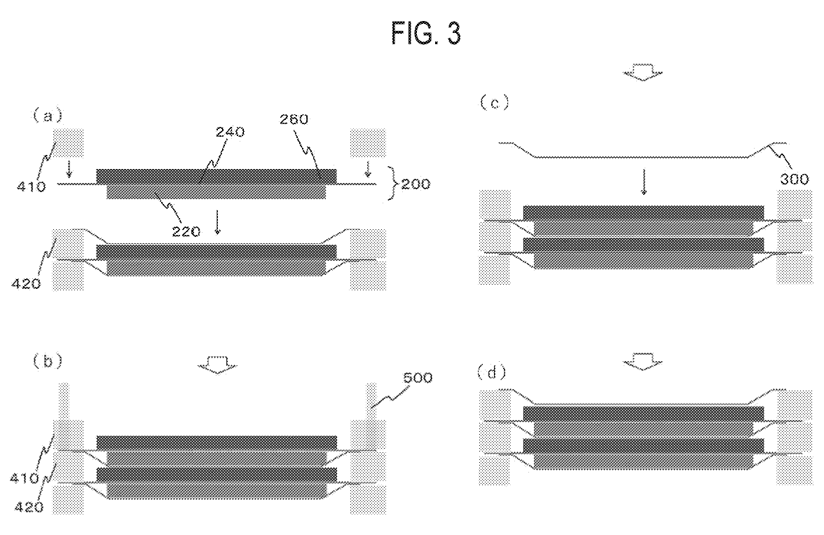

In the present disclosure, the electrode stack 200 and the first resin sealing member 410 may be stacked in this order on the second resin sealing member 420 at the end part of the current collector layer 240 (part (c) of FIG. 2 and part (a) of FIG. 3).

### First and Second Resin Sealing Members

According to the present disclosure, in the first resin sealing member and the second resin sealing member, the first resin sealing member, the electrode stack, and the second resin sealing member are stacked in this order at the end part of the current collector layer. Each of one surface of the end part and the first resin sealing member, the other surface of the end part and the second resin sealing member, and the first resin sealing member and the second resin sealing member is welded.

In the present disclosure, a material of the resin sealing member can be freely selected within a range in which the current collector layer can be sufficiently welded to the first and/or second resin sealing members and the first resin sealing member can be sufficiently welded to the second resin sealing member. The material is not particularly limited, but examples thereof include polypropylene (PP), polyolefin, polyester copolymer, polyethylene terephthalate, and nylon, but the present disclosure is not limited thereto.

In the present disclosure, a thickness of the first and second resin sealing members is not particularly limited. The thickness may be 100 μm or more, 300 μm or more, 500 μm or more, or 800 μm or more, and may be 5000 μm or less, 4000 μm or less, 3000 μm or less, 2000 μm or less, or 1000 μm or less.

In the present disclosure, a width of the first and second resin sealing members is not particularly limited. The width may be 1 mm or more, 3 mm or more, 5 mm or more, or 7 mm or more, and may be 200 mm or less, 100 mm or less, 50 mm or less, 30 mm or less, or 10 mm or less.

### Step c

Next, in the method of manufacturing an electrode stack module according to the present disclosure, the end part of the current collector layer is heated by irradiating the end part with a laser beam through the first resin sealing member from the stacking direction of the electrode stack. As a result, each of one surface of the end part and the first resin sealing member, the other surface of the end part and the second resin sealing member, and the first resin sealing member and the second resin sealing member is welded.

In the present disclosure, the end part of the current collector layer 240 is heated by irradiating the end part with a laser beam 500 through the first resin sealing member 410 from the stacking direction of the electrode stack 200 (part (d) of FIG. 2 and part (b) of FIG. 3). As a result, each of one surface of the end part of the current collector layer 240 and the first resin sealing member 410, the other surface of the end part of the current collector layer 240 and the second resin sealing member 420, and the first resin sealing member 410 and the second resin sealing member 420 can be welded. In the present disclosure, as shown in part (d) of FIG. 2, the end part of the current collector layer 240 can be continuously irradiated with the laser beam from one point of the end part of the current collector layer 240, and thus the peripheral edge portion of the electrode stack can be welded and the electrode stack can be sealed.

In the present disclosure, as shown in part (d) of FIG. 2, the step (c) may include pressurizing the current collector layer 240 and the first resin sealing member 410 with a pressurizing member 600 transparent to the laser beam 500 and performing irradiation with the laser beam 500. As a result, at least the welding of the current collector layer 240 and the first resin sealing member 410 and the welding of the current collector layer 240 and the second resin sealing member 420 can be improved.

In addition, in the present disclosure, the first resin sealing member 410 may be welded to a separator 300 after the step (c) (part (e) of FIG. 2 and parts (c) and (d) of FIG. 3). In this case, examples of a method of welding the separator to the first resin sealing member include thermal welding, but the present disclosure is not limited thereto.

As shown in part (f) to part (j) of FIG. 2, the electrode stack module in which two or more electrode stacks are stacked may be manufactured by repeating the method of the present disclosure.

### Laser Beam

In the present disclosure, the laser beam irradiation is performed through the first resin sealing member from the stacking direction of the electrode stack to heat the end part of the current collector layer. In the present disclosure, a wavelength of the laser beam satisfies the following (i) and (ii):

(i) an absorption rate of the laser beam in the current collector layer is 50% or more, and

(ii) an absorption rate of the laser beam in the first resin sealing member is 10% or less.

In the present disclosure, the absorption rate of the laser beam in the current collector layer is not particularly limited, but may be 50% or more, 60% or more, or 70% or more, and may be 90% or less, 85% or less, or 80% or less.

In the present disclosure, the absorption rate of the laser beam in the resin sealing member is not particularly limited, but may be 0.5% or more, 1.0% or more, or 3% or more, and may be 10% or less, 8% or less, or 5% or less.

In the present disclosure, the transmittance of the laser beam in the current collector layer and the resin sealing member can be measured by a spectrophotometric method, for example, by using an integrating sphere having a diameter of 150 mm as a detector in a spectrophotometer (manufactured by PerkinElmer, Inc.; LAMBDA950) to measure the transmittance at a wavelength of 250 to 2,000 nm. In addition, the transmittance at a wavelength of 2,000 to 25,000 nm can be measured by using an integrating sphere (manufactured by PerkinElmer, Inc.; RSA-PE-200-ID) having a diameter of 150 mm that is coated with gold on the inside, as a detector in an FT-IR (manufactured by PerkinElmer, Inc.; System2000 type).

In the present disclosure, the wavelength of the laser beam is not particularly limited. The wavelength may be 285 nm or more, 345 nm or more, 400 nm or more, or 450 nm or more, and may be 1150 nm or less, 1000 nm or less, 950 nm or less, or 850 nm or less.

### Pressurizing Member

In the present disclosure, the pressurizing member pressurizes the current collector layer and the first resin sealing member. A material of the pressurizing member is not particularly limited as long as it is transparent to the laser beam.

The present disclosure will be described in more detail with reference to Embodiments shown below, but the scope of the present disclosure is not limited to these Embodiments.

### Embodiments

### Embodiment 1

### Lamination of Current Collector Layer and Resin Sealing Member

In Embodiments 1 and 2, it was confirmed that the current collector layer and the resin sealing member could be welded using the method of the present disclosure. As the resin sealing member, a Modic H511 (Mitsubishi Chemical Corporation) having a thickness of 800 μm was prepared, and as the current collector layer, a copper foil (welding width: 10 mm, welding length: 90 mm) having a carbon coating on the surface was prepared, respectively. The current collector layer was disposed to be sandwiched between two resin sealing members, and the lamination portion of the current collector layer and the resin sealing member was pressurized by the pressurizing member.

### Irradiation with Laser Beam and Welding of Resin

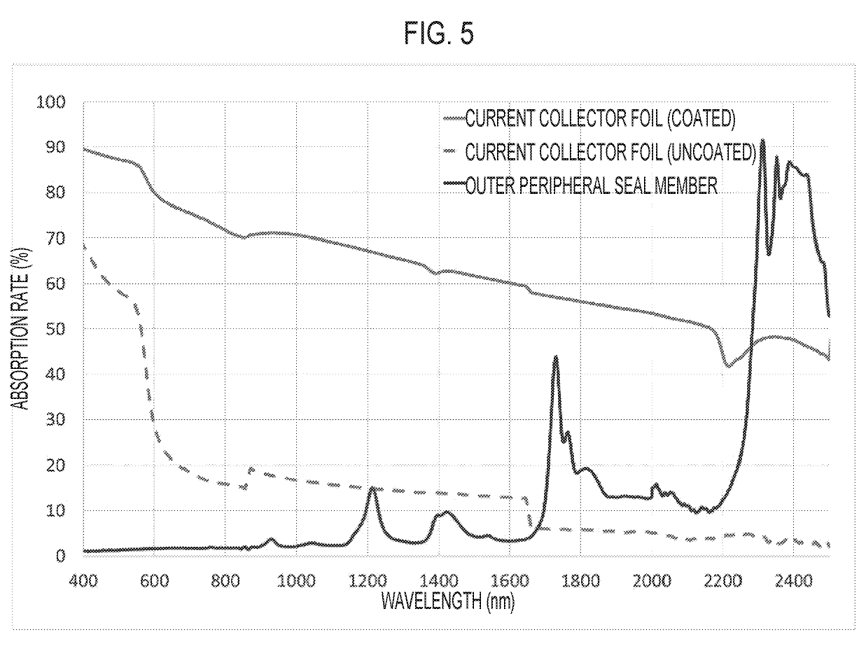

The current collector layer was heated by irradiating the stacked portion of the current collector layer and the resin sealing member with a laser beam from the stacking direction through the pressurizing member, and the current collector layer and the two resin sealing members were welded to obtain a stack according to Embodiment 1. The relationship between the wavelength of the laser beam irradiated in the present embodiment and the absorption rates of the current collector layer and the resin sealing member is shown in FIG. 5. In this case, the laser beam wavelength was 1060 nm, the absorption rate of the laser beam in the current collector layer was 50% or more, and the absorption rate of the laser beam in the resin sealing member was 10% or less. Other conditions of the laser beam irradiation were as follows:

### Laser beam diameter: 12 mm × 28 mm

### Laser output: 1000 W

### Scanning speed: 400 mm/sec

### Embodiment 2

A stack according to Embodiment 2 was obtained in the same manner as in Embodiment 1, except that a copper foil having no carbon coating on the surface was used as the current collector layer and the laser wavelength was set to 450 nm. In this case, the laser wavelength was 1060 nm, the absorption rate of the laser beam in the current collector layer was 50% or more, and the absorption rate of the laser beam in the resin sealing member was 10% or less.

### Evaluation

In the stacks according to Embodiments 1 and 2, the current collector layer and the resin sealing member were sufficiently welded to each other at the stacked portion of the current collector layer and the resin sealing member.

### Embodiment 3

In Embodiment 3, it was confirmed that a stack in which a plurality of current collector layers and a plurality of resin sealing members were stacked and welded to each other alternately by repeating the method of the present disclosure could be produced.

### Production of Stack

The current collector layer and the resin sealing member were further stacked in this order on the resin sealing member welded in Embodiment 1, and the current collector layer and the resin sealing member were welded by irradiating the stacked portion with a laser beam. This was further repeated three times to produce a stack in which the current collector layer and the resin sealing member were stacked alternately, and the stack included five current collector layers.

### Evaluation

It was confirmed that a stack in which the current collector layers and the resin sealing members were stacked alternately to each other could be produced by repeatedly using the method of the present disclosure.

What is claimed is:

1. A method of manufacturing an electrode stack module, the method comprising:
(a) providing an electrode stack that includes a positive electrode active material layer, a current collector layer, and a negative electrode active material layer in order of the positive electrode active material layer, the current collector layer, and the negative electrode active material layer, and in which an end part of the current collector layer protrudes;
(b) stacking a first resin sealing member, the electrode stack, and a second resin sealing member in order of the first resin sealing member, the electrode stack, and the second resin sealing member at the end part; and
(c) heating the end part of the current collector layer by irradiating the end part with a laser beam through the first resin sealing member from a stacking direction of the electrode stack, and welding each of one surface of the end part and the first resin sealing member, the other surface of the end part and the second resin sealing member, and the first resin sealing member and the second resin sealing member, wherein:
a wavelength of the laser beam satisfies both of (i) and (ii):
(i) an absorption rate of the laser beam in the current collector layer is 50% or more; and
(ii) an absorption rate of the laser beam in the first resin sealing member is 10% or less.

2. The method according to claim 1, wherein (c) includes irradiating the end part with the laser beam while the current collector layer and the first resin sealing member are pressurized with a pressurizing member transparent to the laser beam.

3. The method according to claim 1, wherein the wavelength of the laser beam is from 285 nm to 1150 nm.

4. The method according to claim 1, wherein a thickness of the first resin sealing member is 800 μm or more.

5. The method according to claim 1, wherein a width of the first resin sealing member is 200 mm or less.
